(19) United States
(12) Patent Application Publication
(10) Pub. No.: US 2013/0165260 A1
(43) Pub. Date: Jun. 27, 2013

(54) Golf Ball With Co-Molded Core And Medial Layer And Method Of Making

(71) Applicant: Arthur Molinari, Portland, OR (US)

(72) Inventor: Arthur Molinari, Portland, OR (US)

(73) Assignee: NIKE, Inc., Beaverton, OR (US)

(21) Appl. No.: 13/484,181

(22) Filed: May 30, 2012

Related U.S. Application Data
(60) Provisional application No. 61/580,549, filed on Dec. 27, 2011.

(51) Int. Cl. A63B 37/02; B29C 45/14

(52) U.S. Cl. 473/355; 473/371; 264/267

(57) ABSTRACT

A golf ball having a core, an outer core layer, a medial layer, and a cover is disclosed, as well as a method of making. The outer core layer defines perforations therethrough. The core and medial layer are formed integrally through the perforations.

### CROSS-REFERENCE TO RELATED APPLICATION

This application claims priority under 35 U.S.C. §119(e) to U.S. Provisional Patent Application No. 61/580,549, entitled “Golf Ball With Co-Molded Core And Medial Layer And Method Of Making”, and filed on Dec. 27, 2011, which application is hereby incorporated by reference.

### FIELD

The present application relates generally to a multi-layer golf ball. More specifically, the present application relates to a golf ball that includes a perforated outer core layer. A method of making the ball creates a core and a medial layer that are co-formed around the perforated outer core layer.

### BACKGROUND

Golf balls are conventionally made from various types of materials. The material selected depends on the play conditions desired for the ball. In some instances, a designer may select a harder core material and in other instances the designer may select a softer core material. The core material selected affects how the ball performs and how a golfer perceives the feel of the ball.

Conventional golf balls include a series of layers. The layers are each selected to provide certain performance characteristics that, in combination, form a golf ball that has an appropriate feel for the golfer and provides an appropriate trajectory for the golfer's technique. Frequently, there is a plurality of layers that are made separately and then joined together. Alternatively, the layers may be overmolded.

However, the use of a plurality of layers creates, by necessity, a discontinuity between the layers. This discontinuity can create a situation where the layers may cause one another to deteriorate or the multiple materials can cause cracking of the outer surface due to their different performance characteristics. In addition, the difference in the layers may create shifting of the layers relative to one another within the ball.

In addition, the core of a golf ball is traditionally fairly small in diameter. The core is often surrounded by varying types of outer core layers, medial layers, mantle layers, or the like. If it is desired to use a single material for, for example, a core layer and a medial layer, the two are often separated completely by an outer core layer or the medial layer is formed of two parts and mated with the core layer. Therefore, rather than assisting in the durability of the ball, the use of two layers of identical material instead may enhance the deterioration of the ball.

It may be desirable instead to create a ball that incorporates multiple layers that are secured to one another in order to minimize shifting between the layers. In addition, it may be desirable to use a manufacturing method that invites the use of a single material as a core material and a medial layer partially separated by an outer core layer in order to create a different performance from that available without the outer core layer.

### SUMMARY

An embodiment of a golf ball includes a core, an outer core layer, a medial layer, and a cover. The outer core layer may be hollow and may be positioned radially outward of and partially surround the core. At least one perforation may be defined through the outer core layer. The medial layer may be positioned radially outward of the outer core layer. The medial layer may be made of a material that is capable of projecting into the at least one perforation in the outer core layer. The cover may be positioned radially outward of and partially surround the medial layer. In some embodiments, the core and medial layer are formed of the same material.

In another embodiment, a method of making a golf ball is disclosed. A hollow outer core layer may be placed in a mold cavity. The hollow outer core layer may define at least one perforation therethrough. The mold cavity may be at least partially filled with a material having a viscosity and particle size capable of passing through the at least one perforation. The method may be used to mold a core within the outer core layer and a medial layer outside the outer core layer at substantially the same time.

In another embodiment, a golf ball includes a first stratum and a second stratum. The first stratum defines at least one perforation therethrough. The second stratum includes three substrata. The first substratum includes a core having an outer surface. The third substratum has an outer surface and an inner surface. The second substratum includes at least one finger extending between the inner surface of the third substratum and the outer surface of the first substratum. The at least one finger extends through the at least one perforation. In some embodiments, the first stratum defines a plurality of perforations and the second substratum includes a corresponding plurality of fingers, one finger extending through each perforation.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a cross-sectional view of one embodiment of a golf ball;

FIG. 2 is a perspective view of one embodiment of an inner core layer;

FIG. 3 is a perspective view of another embodiment of an inner core layer;

FIG. 4 is a cross sectional view of an embodiment of a mold in which an embodiment of an inner core layer has been positioned;

FIG. 5 is a cross sectional view of the mold of FIG. 4 partially filled with a first material;

FIG. 6 is a cross sectional view of the mold of FIG. 4 substantially filled with the first material;

FIG. 7 is a cross sectional view of an embodiment of a second mold in which a core, inner core layer, and medial layer have been positioned, partially filled with a third material; and

FIG. 8 is an alternative embodiment of a golf ball.

### DETAILED DESCRIPTION

The present disclosure relates to a golf ball that has a core and medial layer that are molded together or co-molded. The present disclosure also relates to a method of making such a golf ball.

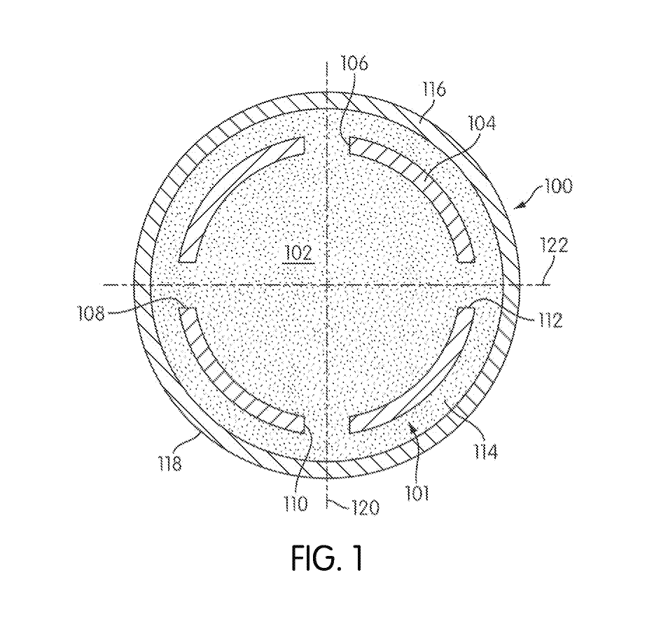

Turning first to FIG. 1, an embodiment of a golf ball 100 is shown. Golf ball 100 includes a plurality of layers. The innermost layer is core 102. Outer core layer 104 partially surrounds and is positioned radially outward of core 102. Medial layer 114 at least partially surrounds and is positioned radially outward of outer core layer 104. Cover 116 at least partially surrounds and is positioned radially outward of medial layer 114. Accordingly, in one aspect, golf ball 100 can be considered as including four layers. Core 102, outer core layer 104, and medial layer 114, including all the sub-parts, may be considered the internal layers of ball 100, and cover 116 may be considered the external layer.

Outer core layer 104 may be hollow and may be substantially spherical. Outer core layer 104 may include a plurality of perforations that penetrate through outer core layer 104. In the embodiment shown in FIG. 1 along the specific cross section taken, there are four perforations shown, specifically first perforation 106, second perforation 108, third perforation 110, and fourth perforation 112. In FIG. 1, first perforation 106, second perforation 108, third perforation 110, and fourth perforation 112 are shown as being substantially equal in size and approximately evenly spaced around a circumference of outer core layer 104. However, such sizing and arrangement are exemplary only. Other possible embodiments and examples are shown in other FIGS. and are interchangeable with the outer core layer 104 shown in FIG. 1. In some embodiments, outer core layer 104 may be made in a process disclosed in U.S. Patent Publication No. ______, currently Provisional Application Ser. No. 61/580,537, entitled “Method of Molding a Single-Piece Hollow Shell Including Perforations” [attorney docket No. 72-1157], filed on Dec. 27, 2011, the disclosure of which is incorporated by reference. In some embodiments, the ball of this disclosure may be used in accordance with a recycling process as described in U.S. Patent Publication No. ______, currently Provisional Application Ser. No. 61/580,525, entitled “Method of Recycling Ball and Ball for Use in Recycling Method” [attorney docket No. 72-1169], filed Dec. 27, 2011, the disclosure of which is incorporated by reference.

Cover 116 is shown in the FIGS. in simplified form. In a commercial version, cover 116, and in particular, outer surface 118 of cover 116, is configured to be struck by a golf club. Accordingly, cover 116 may include various dimples, frets or lands, projections, printing, or any other features that a designer thinks would be desirable in affecting the flight path of ball 100. The particular patterns on cover 116 may be determined by a person having ordinary skill in the art. Cover 116 may be designed to be scuff resistant. Cover 116 may be made of any material deemed desirable for a golf ball cover, such as SURLYN or other polyurethane elastomer that has appropriate properties for a golf ball cover.

As shown in FIG. 1, first material 101 is used to form core 102 and medial layer 114 and projects into and passes through first perforation 106, second perforation 108, third perforation 110, and fourth perforation 112. First perforation 106, second perforation 108, third perforation 110, and fourth perforation 112 are shaped and sized in such a manner as to allow passage of first material 101 through first perforation 106, second perforation 108, third perforation 110, and fourth perforation 112. Sizing and shaping each of first perforation 106, second perforation 108, third perforation 110, and fourth perforation 112 in this manner allows core 102 and medial layer 114 to be joined to or formed integrally with one another. As shown in FIG. 1, first material 101 fills each of first perforation 106, second perforation 108, third perforation 110, and fourth perforation 112.

The qualities of the first material and the projections may vary depending on the full design of the ball. For example, in some embodiments, the first material may have a higher viscosity than the material shown in FIG. 1. In some embodiments, the outer core layer may be thicker than that shown in FIG. 1. In such an instance, it may be possible for the first material to be capable of only projecting partially through at least one of the perforations in the outer core layer from one or both of the core side or the medial layer side. In addition, in some embodiments, depending on the shape and size of the perforations and the flow characteristics of the first material, some perforations in the outer core layer may be completely filled and other perforations may be only partially filled. In some embodiments, the first material may join the core and medial layer through one or more projections, but the size of the area in which the core and medial layer are joined may be narrower or smaller in other ways than by completely filling each perforation.

The material selected to be used as the first material may be any of the typical materials used in manufacturing cores or other interior layers of a conventional golf ball. For example, the first material may be a thermoplastic urethane or rubber, such as a polybutadiene rubber. In many embodiments, it may be useful to use a material that is solid, rather than liquid, at room temperature.

The material used to form outer core layer 104 may be similar to that used for core 102 and medial layer 114. However, it may be desirable to form outer core layer 104 from a second material different from first material 101. In some embodiments, it may be desirable for first material 101 to be softer than the second material, and in other embodiments, it may be desirable for the second material to be softer than first material 101. It may be desirable for first material 101 and the second material to differ in other respects, such as elasticity, melting temperature, and the like. Golf balls have often been made with layers having different material properties, and a person having ordinary skill in the art can select appropriate materials for the core and medial layers, outer core layer, and cover that provide a desired set of flight properties.

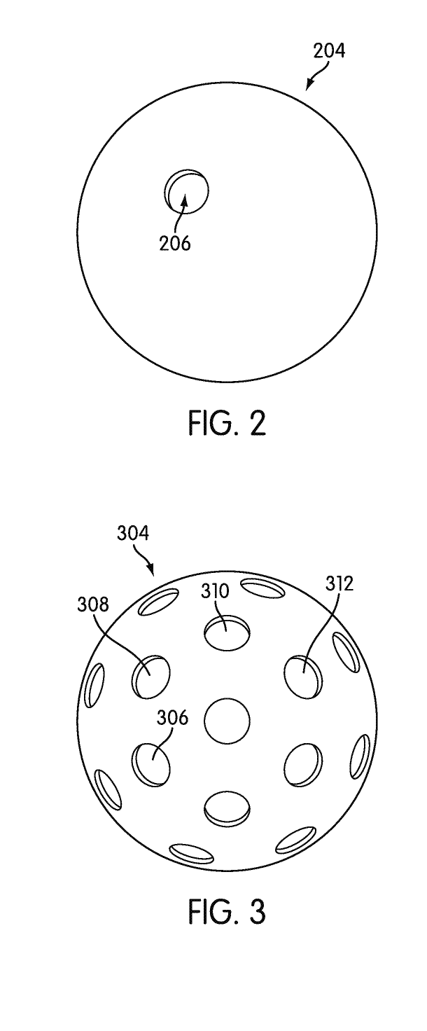

The embodiment of outer core layer 104 shown in FIG. 1 defines four perforations, namely, first perforation 106, second perforation 108, third perforation 110, and fourth perforation 112. First perforation 106 and third perforation 110 are generally aligned with one another along first axis 120. Second perforation 108 and fourth perforation 112 are generally aligned with one another along second axis 122. In the embodiment shown in FIG. 1, first axis 120 and second axis 122 are generally perpendicular to one another. This number and placement of perforations is exemplary and may take other forms, as shown in FIGS. 2 and 3.

FIG. 2 shows an alternative embodiment of outer core layer 204. Outer core layer 204 is the simplest version of an outer core layer in accordance with the present disclosure. As shown in FIG. 2, outer core layer 204 is a hollow sphere. Outer core layer 204 defines a single perforation 206. As will be apparent to one having ordinary skill in the art, a single perforation 206 on an outer core layer 204 has no orientation relative to other perforations or other structure.

FIG. 3 shows another alternative embodiment of outer core layer 304. Outer core layer 304 defines a plurality of perforations therethrough. Specifically, outer core layer 304 defines first exemplary perforation 306, second exemplary perforation 308, third exemplary perforation 310, fourth exemplary perforation 312, and a plurality of additional perforations. Each perforation may be aligned with another perforation or may be unaligned with any other perforation. Alternatively, some perforations may be aligned with another perforation while other perforations remain unaligned with any other perforation.

A person having ordinary skill in the art will be able to select an outer core layer that has the appropriate properties useful for a particular application. In some embodiments, it may be desirable for the core and medial layers to be joined together over as much surface area as possible. In such an instance, a person having ordinary skill in the art might select an outer core layer that defines a larger number of perforations. In other instances, it may be desirable to include a larger amount of the second material. In such an instance, a person having ordinary skill in the art might select an outer core layer that defines a smaller number of perforations or an outer core layer that has a larger thickness. In yet other instances, a person having ordinary skill in the art may wish to maximize the flow of the first material through the outer core layer in the molding process, as will be described in greater detail below. In such an instance, the selection of a perforation pattern that encourages a particular flow pattern may be desirable. Based on the characteristics desired by the person having ordinary skill in the art, the outer core layer and perforation configuration can be designed to accommodate the desired results.

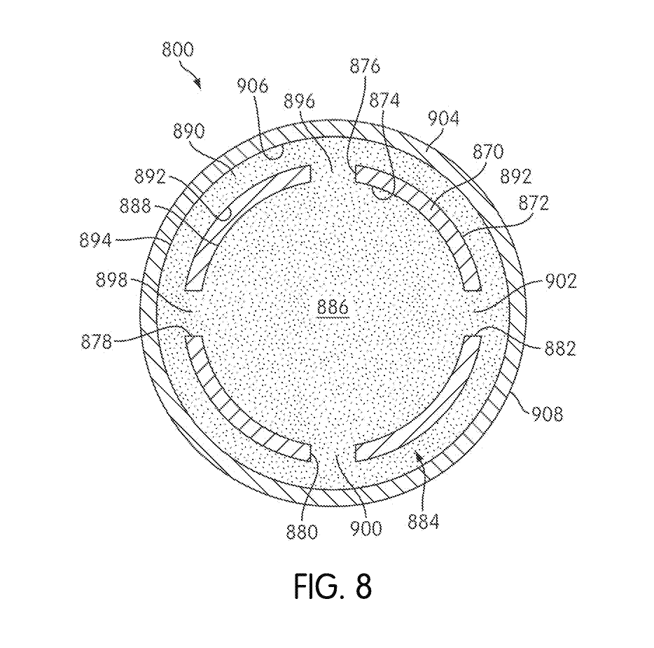

Ball 100 was described above as having four layers, namely, core 102, outer core layer 104, medial layer 114, and cover 116. However, ball 100 may also be described as having three layers or strata. FIG. 8 illustrates ball 800 having the same structure as ball 100 of FIG. 1. As shown in FIG. 8, first stratum 870 is hollow and may be substantially spherical. First stratum 870 has an outer surface 872 and an inner surface 874. First stratum 870 defines a plurality of perforations passing through first stratum 870 and extending from outer surface 872 to inner surface 874. In the embodiment shown in FIG. 8, the perforations include first perforation 876, second perforation 878, third perforation 880, and fourth perforation 882. The cross-sectional shape of the perforations may be any shape that is reasonably feasible in a given molding process and that provide appropriate stability to first stratum 870. The perforations may have the same shape or different shapes. While there are four perforations shown along this cross-sectional line, first stratum 870 may have any desirable number of perforations. However, it is desirable for first stratum 870 to define at least one perforation.

Second stratum 884 has three substrata positioned in different locations relative to first stratum 870. First substratum 886 comprises and may be considered to generally be a substantially spherical solid that is desirably positioned at the center of ball 800. First substratum 886 may form the core of ball 800. Because first substratum 886 is generally solid, it includes only an outer surface 888. Outer surface 888 of first substratum 886 is adjacent inner surface 874 of first stratum 870.

Third substratum 890 comprises and many be generally considered to be substantially hollow and substantially spherical. Because it is generally hollow, third substratum 890 includes inner surface 892 and outer surface 894. Inner surface 892 of third substratum 890 is positioned adjacent outer surface 872 of first stratum 870.

The second substratum of second stratum 884 comprises a plurality of fingers. These include first finger 896, second finger 898, third finger 900, and fourth finger 902. Each of first finger 896, second finger 898, third finger 900, and fourth finger 902 extends between outer surface 888 of first substratum 886 and inner surface 892 of third substratum 890. Each finger could be considered equally to extend from inner surface 892 to outer surface 888 or to extend from outer surface 888 to inner surface 892. In addition, second substratum 884 and first stratum 870 could be considered to be sandwiched between first substratum 886 and third substratum 890.

In many embodiments, it may be desirable for the number of fingers in the second substratum to correspond with the number of perforations in the first stratum. Accordingly, if the first stratum defines only a single perforation, the second substratum would desirably only include a single finger. Also, as will be discussed later in the disclosure, a molding process may be used that forms all of the second stratum integrally. In such an instance, the first substratum, the second substratum, and the third substratum are integrally formed and form a single piece. The use of such a molding process increases the likelihood that a finger will be positioned in each perforation. In addition, the use of such a molding process facilitates or encourages the material forming the second stratum to completely fill the mold cavity. Such a molding process tends to create a ball where at least one finger in the second substratum completely fills at least one perforation in the first stratum. In many cases, each finger will substantially fill a corresponding one of the perforations. The degree to which each perforation will be filled by a corresponding finger depends on many factors, including the materials selected for the first stratum and the second stratum, the temperature of the mold, various atmospheric conditions, and the like.

Covering second stratum 884 may be cover 904. Cover 904 may be substantially hollow and substantially spherical. Accordingly, cover 904 may have inner surface 906 and outer surface 908. Cover 904 covers first stratum 870 and all three substrata of second stratum 884. Inner surface 906 of cover 904 is desirably positioned adjacent outer surface 894 of third substratum 890. Outer surface 908 of cover 904 desirably forms the outer surface of the ball to be struck by a user's club. Cover 904 may be any generally conventional cover. The properties of cover 904 may be those described in connection with cover 116 in FIG. 1. Outer surface 908 of cover 904 may be configured in a manner as described earlier in connection with outer surface 118 of FIG. 1. Similarly, the materials selected and limitations described in connection with outer core layer 104 may be analogously applied to first stratum 870 and the materials selected and limitations described in connection with core 102 and medial layer 114 may be analogously applied to second stratum 884. First stratum 870 and second stratum 884, together with all the sub-parts thereof may be considered the internal strata of ball 800 and cover 904 may be considered the external stratum of ball 800.

Those in the art will appreciate that the number of strata in any particular ball is not limited to the specific strata identified above. Other embodiments of balls may include any number of strata with fingers and corresponding perforations. It will also be appreciated that any number of fingers could be provided on any strata with corresponding perforations on any adjacent strata.

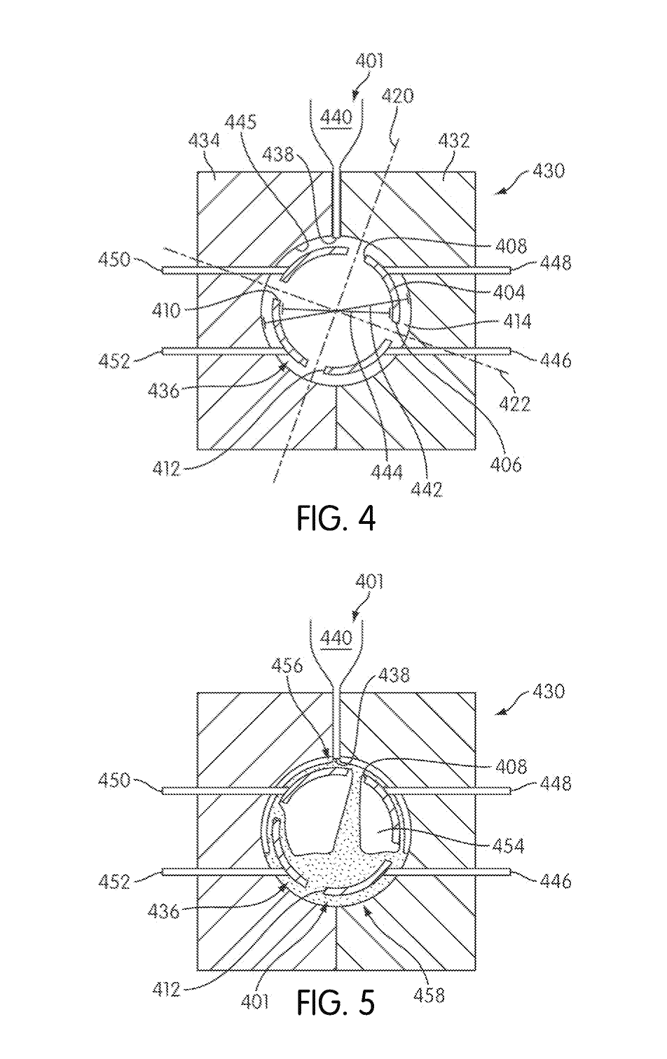

Turning now to FIGS. 4-7, a method of making a golf ball is disclosed. In FIGS. 4-7, the configuration of the outer core layer is shown as being similar to that shown in FIG. 1. However, a person having ordinary skill in the art will be able to select another configuration of outer core layer that would be appropriate in a particular embodiment and can modify the process shown in FIGS. 4-7 to accommodate that configuration of outer core layer.

Throughout the figures, the molds, nozzles, and pins are in exemplary configurations. In some embodiments, these configurations may be altered. For example, in the figures, the seam lines of the molds are oriented to that the molds will separate by moving to the sides (in a horizontal direction), while the nozzle is positioned at the top of the mold. As will be apparent to those in the art, the molds and nozzle may be re-oriented so that the mold halves will separate by lifting one mold half away from the other or moving both halves away from each other (in a vertical direction) while the nozzle will inject from a side of the mold. The orientation of the mold halves with respect to each other and/or the nozzle and/or the pins may be shifted without undue experimentation.

As noted in FIG. 4, a golf ball can be molded using mold 430. Mold 430 may be one of a variety of types of molds, depending on the material to be molded therein. In FIGS. 4-6, first mold 430 is shown as a standard injection mold. First mold 430 may include first mold portion 432 and second mold portion 434. First mold portion 432 and second mold portion 434 can be separated from one another to place items in first mold 430 before molding occurs or to remove the formed material after molding. First mold portion 432 and second mold portion 434 form first mold cavity 436 therein. First injection port 438 may be present, for example, at the top of first mold cavity 436. First injection port 438 may be in fluid communication with first reservoir 440 that contains first material 401. In some embodiments, first material 401 may be a highly neutralized polymer or a thermoplastic urethane. First material 401 is introduced into first mold cavity 436 from first reservoir 440 via first injection port 438.

First mold 430 may be heated or cold, depending on what material is used as the first material and what its properties are. For example, if the material used is a thermosetting material, first mold 430 may be heated so that the material is heated to its setting temperature. If, instead, the material is thermoplastic, first mold 430 may only be heated to promote the even flow of first material 401 into first mold cavity 436 to ensure that first mold cavity 436 is evenly filled. Other materials may allow first mold 430 to remain at about room temperature during molding. After first material 401 is treated in an appropriate manner to allow first material 401 to be appropriately molded, first mold 430 may be cooled or allowed to cool, if necessary. Once first mold 430 reaches room temperature and the material is allowed to cure for the appropriate amount of time, the intermediate material formed by the molding process can be removed from first mold 430. FIG. 4 shows one example of an appropriate structure for molding the intermediate structure. However, this precise structure need not be used. Instead, another structure appropriate for molding the intermediate structure could be used that is appropriate for the materials desired for the intermediate structure.

As shown in FIG. 4, first mold cavity 436 has a diameter 442 and outer core layer 404 has a diameter 444. Diameter 442 of first mold cavity 436 is larger than diameter 444 of outer core layer 404. When the diameter 444 of outer core layer 404 is smaller than the diameter 442 of first mold cavity 436, then outer core layer 404 is spaced from or positioned away from the interior wall 445 of the mold cavity 436. In order to mold an intermediate product with outer core layer 404 embedded therein, outer core layer 404 may desirably be supported within first mold cavity 436. In some embodiments, it may be desirable for the first mold cavity 436 to be spherical and have a substantially spherical interior wall 445 to correspond generally in shape to a substantially spherical outer core layer 404.

As shown in FIG. 4, one option for properly positioning outer core layer 404 in first mold cavity 436 is to support outer core layer 404 with a plurality of pins. FIG. 4 shows the use of first pin 446, second pin 448, third pin 450, and fourth pin 452. First pin 446, second pin 448, third pin 450, and fourth pin 452 are designed to be retractable within first mold cavity 436.

FIG. 5 shows a first injection molding step. As shown in FIG. 5, first material 401 is injected via first injection port 438 between the interior wall 445 of first mold cavity 436 and outer core layer 404. While this configuration is shown in FIG. 5, alternative configurations may be possible. In some embodiments, it may be desirable to align a perforation in outer core layer 404 with first injection port 438 and to insert first injection port 438 into the cavity 454 within hollow outer core layer 404. In other embodiments, it may be desirable to align a perforation with first injection port 438 but to keep first injection port between outer core layer 404 and interior wall 445 of first mold cavity 436.

A person having ordinary skill in the art is able to modify the positioning of the outer core layer 404 within first mold cavity 436 relative to interior wall 445, first injection port 438, and any support structure, such as first pin 446, second pin 448, third pin 450, and fourth pin 452. In many embodiments, it may be desirable to orient outer core layer 404 so that no support penetrates through a perforation. In other embodiments, it may be desired to support outer core layer 404 by inserting a support through one or more perforations. The positioning of first pin 446, second pin 448, third pin 450, and fourth pin 452 is exemplary only and may be modified to allow the appropriate support of a desired outer core layer 404.

The positioning of outer core layer 404 relative to first injection port 438 is also a consideration in the injection molding process. The material injected into mold cavity 436 from reservoir 440 through first injection port 438 may be selected to have a viscosity and particle size to make first material 401 capable of passing through at least one of the perforations through outer core layer 404. First material 401 must be injected at sufficient pressure and at an appropriate temperature to allow first material 401 to pass through at least one perforation in outer core layer 404 without deforming outer core layer 404. Accordingly, in selecting an orientation of the perforations on outer core layer 404 relative to first injection port 438, the person having ordinary skill in the art must be aware of the weight and pressure limitations of the second material from which outer core layer 404 may be made. In some embodiments, it may be possible for a solid section of outer core layer 404, such as solid section 456, to be positioned directly under first injection port 438 without deforming outer core layer 404. In some embodiments, it may be possible for a perforation to be aligned with first injection port 438 and for first material 401 injected from first injection port 438 to drop into the hollow outer core layer 404 and partially fill the interior of outer core layer 404 without deforming outer core layer 404.

As shown in FIG. 5, when first material 401 is injected into first mold cavity 436, it flows around outer core layer 404 and enters outer core layer 404 through at least one perforation therethrough. As shown in FIG. 5, first material 401 may flow over outer core layer 404 and fall by gravity or other methods to the bottom 458 of the mold cavity. While other orientations of the mold are possible, it is often desirable to use gravity to assist in the molding process, rather than needing to use additional pressure to force a molding material into a mold. When first material 401 falls to bottom 458 of first molding cavity 436, the level of first material 401 in the molding cavity rises. Eventually, as shown in FIG. 5, the level rises as high as fourth perforation 412. When first material 401 reaches this level, it is permitted to penetrate into or pass through fourth perforation 412. In many embodiments, it is desirable for first material 401 to completely fill fourth perforation 412. In other embodiments, it may be desirable for first material 401 to only partially fill fourth perforation 412.

In addition, when first material 401 is flowing over outer core layer 404, it may flow over a perforation. In some embodiments, depending on the orientation of the perforation relative to the flow of first material 401, gravity, and the materials used, first material 401 may flow through the perforation into the hollow area 454 within the hollow, substantially spherical outer core layer 404. An example of such flow is shown in FIG. 5. In FIG. 5, first material 401 is shown as flowing through second perforation 408 into cavity 454.

As first material 401 is injected into first mold cavity 436, it fills first mold cavity 436 and outer core layer 404. As it begins to harden, it becomes capable of supporting outer core layer 404 within first mold cavity 436. As first material 401 begins to harden and support outer core layer 404, first pin 446 and fourth pin 452 can be retracted. As first material 401 begins to further fill first mold cavity 436, second pin 448 and third pin 450 can be retracted. This retraction after the partial hardening of first material 401 allows outer core layer 404 to remain centered within first mold cavity 436 and for first material 401 to evenly fill first mold cavity 436 and outer core layer 404. FIG. 5 shows a state where it may be possible to retract first pin 446 and fourth pin 452 in some embodiments.

While four pins 446, 448, 450, and 452 are shown, and while they are shown protruding only from the sides of first mold cavity 436, these features should not be seen as being limiting. In some embodiments, it may be desirable to place more or fewer pins in first mold cavity 436. In other embodiments, it may be desirable to space the pins more evenly throughout first mold cavity 436. Finally, it may be desirable to include pins on the top or bottom sides of first mold cavity 436. A person having ordinary skill in the art will be able to modify the mold design to provide an appropriate molding environment based on the materials selected and the design characteristics desired.

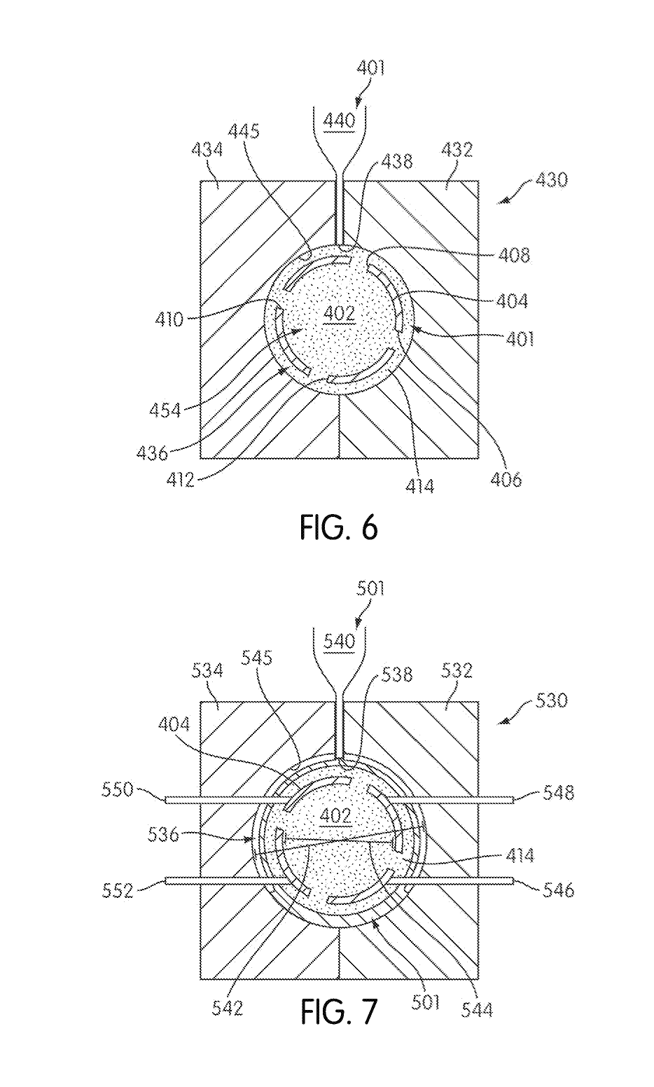

Turning now to FIG. 6, there is shown an embodiment of the mold where the first mold cavity 436 is substantially filled with first material 401. In the embodiment shown in FIG. 6, the first injection port 438 has been retracted to be about even with or recessed from interior wall 445 of mold 430 in order to allow the first material to substantially fill mold cavity 436. As shown in FIG. 6, the injection step allows the filling of the interior 454 of outer core layer 404 to form core 402. The injection step also allows each perforation to be filled with first material 401. As shown in FIG. 6, first perforation 406, second perforation 408, third perforation 410, and fourth perforation 412 are all substantially filled with first material 401. Finally, the space between outer core layer 404 and interior mold wall 445 is filled with first material 401 to form medial layer 414. The use of such a method of molding allows the substantially simultaneous molding of a core 402 and a medial layer 414 partially separated from one another via a perforated outer core layer 404. Such a method allows the partial integration of core 402 and medial layer 414 in a single molding process and minimizes shifting between core 402 and medial layer 414 due to this integration. The degree of integration will vary depending on the materials used and the number, size, and shape of perforations in outer core layer 404.

In describing the molding process, the terms fill and filling are used. A person having ordinary skill in the art will appreciate that these terms in many embodiments do not mean to completely fill a space. In some embodiments, the use of particular materials for a mold and a material to fill the mold may, for example, cause the material to spring back from the mold, particularly upon curing. Accordingly, some small gaps that are caused by such limitations are to be expected in any manufacturing process, and these gaps do not mean that the mold is not filled.

After mold cavity 436 is substantially filled with first material 401, first material 401 may be cured, when necessary or desirable. Various materials that are appropriate for use in the present embodiments have different curing requirements. If a thermosetting resin is used as the first material, the curing process often requires the mold to be heated after it is filled. If a thermoplastic resin is used as the first material, the curing process often requires the mold to be cooled after it is filled. Other materials might simply require the passage of time to cure. After first material 401 is cured, first mold portion 432 and second mold portion 434 are separated from one another and the intermediate product is removed from first mold 430.

FIG. 7 shows the use of second mold 530 to form a cover over the intermediate product formed in the steps shown in FIGS. 4-6. Mold 530 may be one of a variety of types of molds, depending on the material to be molded therein. In FIG. 7, second mold 530 is shown as a standard injection mold. Second mold 530 may include first mold portion 532 and second mold portion 534. First mold portion 532 and second mold portion 534 can be separated from one another to place items in first mold 530 before molding occurs or to remove the formed material after molding. First mold portion 532 and second mold portion 534 form second mold cavity 536 therein. Second injection port 538 may be present, for example, at the top of second mold cavity 536. Second injection port 538 may be in fluid communication with second reservoir 540 that contains third material 501. In some embodiments, third material 501 may be a thermoplastic urethane, such as SURLYN®. Third material 501 is introduced into second mold cavity 536 from second reservoir 540 via second injection port 538. Although not shown in FIG. 7, the interior wall 545 of second mold cavity 536 may be patterned to mold the dimple pattern of the ball cover onto the ball cover in this step.

As shown in FIG. 7, one option for properly positioning medial layer 414 in second mold cavity 536 is to support medial layer 414 with a plurality of pins. FIG. 7 shows the use of fifth pin 546, sixth pin 548, seventh pin 550, and eighth pin 552. Fifth pin 546, sixth pin 548, seventh pin 550, and eighth pin 552 are designed to be retractable within third mold cavity 536. As third material 501 is injected into second mold cavity 536, it fills second mold cavity 536. As it begins to harden, it becomes capable of supporting medial layer 414 within second mold cavity 536. As third material 501 begins to harden, fifth pin 546 and eighth pin 552 can be retracted. As third material 501 begins to further fill second mold cavity 536, sixth pin 548 and seventh pin 550 can be retracted. This retraction after the partial hardening of third material 501 allows medial layer 414 to remain centered within second mold cavity 536 and for third material 501 to evenly fill second mold cavity 536.

While four pins 546, 548, 550, 552 are shown, and while they are shown protruding only from the sides of second mold cavity 536, these features should not be seen as being limiting. In some embodiments, it may be desirable to place more or fewer pins in second mold cavity 536. In other embodiments, it may be desirable to space the pins more evenly throughout second mold cavity 536. Finally, it may be desirable to include pins on the top or bottom sides of second mold cavity 536. A person having ordinary skill in the art will be able to modify the mold design to provide an appropriate molding environment based on the materials selected and the design characteristics desired.

Because the outer surface of medial layer 414 is substantially continuous, the placement of the pins may not need to be as complicated as in the placement of the pins in the first molding step, as the consideration of perforation placement is absent. As shown in FIG. 7, second mold cavity 536 has a diameter 542, and medial layer 414 has a diameter 544. Diameter 542 of second mold cavity 536 is larger than diameter 544 of medial layer 414. When diameter 544 of medial layer 414 is smaller than diameter 542 of second mold cavity 536, then medial layer 414 is spaced from or positioned away from interior wall 545 of second mold cavity 536. Because of the space between medial layer 414 and interior wall 545 of second mold cavity 536, third material 501 may be injected from second reservoir 540 through second injection port 538 into the space between medial layer 414 and second mold interior wall 545. This injection step is shown in FIG. 7. This step is substantially conventional, as the configuration of medial layer 414 is substantially the same on the exterior as other medial layers known in the art.

Second mold 530 may also be heated or at room temperature, depending on the material to be injected to form the cover. If second mold 530 is heated, second mold 530 may be allowed to cool. After second mold 530 reaches room temperature or after the cover, medial layer 414, and core 402 have been allowed to cure for an appropriate amount of time, the formed ball may be removed from second mold 530, such as by separating first mold portion 532 from second mold portion 534.

As noted earlier, the configuration of second mold interior wall 545 may be designed to mold the outer surface of the ball. Accordingly, the interior wall 545 may be patterned to allow for dimples and lands and other desirable markings to be molded into the cover of the ball. The precise configuration of the outer ball surface will depend on the desired ball characteristics. A person having ordinary skill in the art will be able to easily design the interior wall 545 with desired characteristics in accordance with the ball's desired characteristics without undue experimentation. The pattern of dimples on the outside of the ball may be designed independently of the characteristics for the inner layers of the ball.

The use of a structure and method as described herein may allow the present embodiments to be used in a variety of advantageous ways. First, the present embodiments may permit the greater reuse of the ball. In many conventional balls, shifting between the various ball layers is prevented or minimized by applying one or more layers of adhesive therebetween. Over time, the adhesive deteriorates due to repeated compression and expansion of the ball, as well as chemical deterioration from exposure to the adjacent ball layers. This deterioration of the adhesive then allows the layers to shift relative to one another, which may create a deterioration of the cover, through cracking or other deformity, and may create a different ball flight profile. After the deterioration has occurred, the golfer discards the ball in favor of one that has not deteriorated. If the present embodiments are used, however, no such deterioration is likely to occur. Because the layers or strata create an integral structure, no adhesive may be necessary to prevent shifting. Accordingly, since adhesive need not be used, it cannot deteriorate. The elimination of the adhesive may extend the life of the ball and allow a golfer to play the ball longer than a ball that includes adhesive.

The elimination of the adhesive also may allow for increased reuse of the ball. The layers or strata of the ball internal to the cover are typically, and also in these embodiments, made of material that has a longer life expectancy than the material used for the cover. A ball cover has increased opportunity for damage relative to internal layers, as the cover comes into contact repeatedly with a club, a tee, and the various materials present on a golf course and atmospheric elements. By further minimizing the deterioration of the internal layers by eliminating the adhesive, a golfer may choose to have a damaged cover of the ball removed and a new cover applied to the internal layers or strata to further extend the ball life. While some adhesive may be used between the cover and the layer or stratum that is immediately adjacent, such an adhesive may be easily removed mechanically or chemically before the new cover is applied.

In addition, the use of a ball with only a minimal amount of adhesive can provide for increased recyclability of the internal layers of the ball. In many instances, recycling of the first and second strata or the core, outer core layer, and medial layer of a golf ball is impeded because an adhesive is used to secure the layers together. The adhesive itself may taint the batch of material. In addition, the use of the adhesive increases greatly the difficulty of separating the materials in a recycling process, as the materials continue to stick together. The elimination of the adhesive from the internal layers or strata of the ball may allow the reuse and recycling of all the internal layers of the ball.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A golf ball, comprising:
a core;
a hollow outer core layer positioned radially outward of and partially surrounding the core and defining at least one perforation therethrough;
a medial layer positioned radially outward of and surrounding the outer core layer, the medial layer being formed of a material capable of projecting into the at least one perforation in the outer core layer; and
a cover positioned radially outward of and surrounding the medial layer.

2. The golf ball according to claim 1, wherein the core and the medial layer are formed of the same material.

3. The golf ball according to claim 1, wherein the outer core layer is hollow and substantially spherical.

4. The golf ball according to claim 1, wherein the material of the medial layer projects through the at least one perforation and is joined with the core.

5. The golf ball according to claim 1, wherein the at least one perforation is filled with material joining the medial layer and the core.

6. A method of making a golf ball, comprising:
positioning a hollow outer core layer in a mold cavity, the outer core layer defining at least one perforation therethrough; and
at least partially filling the mold cavity with a material, the material having a viscosity and particle size capable of passing through the at least one perforation.

7. The method of making a golf ball according to claim 6, wherein the mold cavity has a diameter and the outer core layer has a diameter smaller than the mold cavity diameter, the method further comprising positioning the outer core layer in the mold cavity away from an interior wall of the mold cavity.

8. The method of making a golf ball according to claim 6, wherein the step of at least partially filling the mold cavity with a material comprises injecting the material into the mold cavity between the mold cavity interior wall and the outer core layer.

9. The method of making a golf ball according to claim 8, wherein the injecting step further comprises injecting the material at sufficient pressure to allow the material to pass through the at least one perforation in the outer core layer without deforming the outer core layer.

10. The method of making a golf ball according to claim 9, wherein the injecting step further comprises substantially filling the outer core layer with the material.

11. The method of making the golf ball according to claim 10, wherein the injecting step further comprises substantially filling the mold cavity with the material.

12. The method of making a golf ball according to claim 11, further comprising allowing the material to substantially fill each perforation in the outer core layer.

13. The method of making a golf ball according to claim 12, further comprising curing the material.

14. The method of making a golf ball according to claim 13, further comprising covering the material with a cover.

15. The method of making a golf ball according to claim 6, wherein the mold cavity has a substantially spherical interior wall and the outer core layer is substantially spherical.

16. The method of making a golf ball according to claim 6, further comprising filling the mold cavity with the material.

17. The method of making a golf ball according to claim 16, wherein the step of filling the mold cavity comprises allowing the material to pass through at least one perforation in the outer core layer.

18. The method of making a golf ball according to claim 17, further comprising filling the outer core layer with the material.

19. The method of making a golf ball according to claim 18, further comprising filling each perforation in the outer core layer with the material.

20. The method of making a golf ball according to claim 19, further comprising covering the material with a cover.

21. A golf ball, comprising:
a first stratum defining at least one perforation therethrough; and
a second stratum including three substrata, the three substrata comprising
a first substratum comprising a core having an outer surface;
a third substratum having an outer surface and an inner surface; and
a second substratum comprising at least one finger extending between the inner surface of the third substratum and the outer surface of the first substratum;
wherein the at least one finger extends through the at least one perforation.

22. The golf ball according to claim 21, wherein the first stratum defines a plurality of perforations.

23. The golf ball according to claim 22, wherein the second substratum comprises a plurality of fingers extending from the outer surface of the first substratum to the inner surface of the third substratum, each of the plurality of fingers extending through one of the plurality of perforations.

24. The golf ball according to claim 21, wherein the first substratum, the second substratum, and the third substratum are integrally formed.

25. The golf ball according to claim 21, further comprising a cover covering the third substratum.

26. The golf ball according to claim 21, wherein the at least one finger of the second substratum substantially fills the at least one perforation in the first stratum.

27. The golf ball according to claim 23, wherein each of the plurality of fingers substantially fills one of the plurality of perforations.
